(19) United States
(12) Patent Application Publication
(10) Pub. No.: US 2004/0212857 A1
(43) Pub. Date: Oct. 28, 2004

(54) Control for a photosensor array

(76) Inventor: Kurt E. Spears, Fort Collins, CO (US)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/422,277

(22) Filed: Apr. 23, 2003

(51) Int. Cl. H04N 5/335

(52) U.S. Cl. 358/505

(57) ABSTRACT

A line array of photosensors is exposed two times for each scanline. For the first exposure, charges are transferred from the line array to the charge transfer register after an appropriate exposure time that does not saturate photosensors. While the resulting charges are shifted and converted, the line array is exposed again for a relatively long duration, possibly resulting in overflow. The charges in the line array from the second exposure (during shifting and conversion) are discarded.

### FIELD OF INVENTION

This invention relates generally to photosensor arrays used for optical image scanners.

### BACKGROUND

Image scanners convert a visible image on a document or photograph, or an image in a transparent medium, into an electronic form suitable for copying, storing, or processing by a computer. An image scanner may be a separate device, or an image scanner may be a part of a copier, part of a facsimile machine, or part of a multipurpose device. Reflective image scanners typically have a controlled source of light, and light is reflected off the surface of a document, through an optics system, and onto an array of photosensitive devices. The photosensitive devices convert received light intensity into an electronic signal. Transparency image scanners pass light through a transparent image, for example a photographic positive slide, through an optics system, and then onto an array of photosensitive devices.

Common photosensor technologies include Charge Coupled Devices (CCD), Charge Injection Devices (CID), Complementary-Metal-Oxide (CMOS) devices, and solar cells. Typically, for a CID or a CMOS array, each photosensitive element is addressable. In contrast, CCD arrays commonly transfer charges to charge transfer registers, where charges are serially transferred, bucket-brigade style, to a small number of sense nodes for conversion of charge into a measurable voltage. The present patent document is primarily concerned with photosensor arrays having serial charge transfer registers, also called serial readout registers.

Photosensor arrays for image scanners commonly have at least three line arrays of photosensors, with each line array receiving a different band of wavelengths of light, for example, red, green and blue. Each line array may be filtered, or white light may be separated into different bands of wavelengths by a beam splitter.

For a line array, a line of photosensitive devices receives light from a line on the document, called a scan line. Each photosensitive device, in conjunction with the scanner optics system, measures light intensity from an effective area on the document defining a picture element (pixel) on the image being scanned. Optical sampling rate is often expressed as pixels per inch (or mm) as measured on the document (or object, or transparency) being scanned. Optical sampling rate as measured on the document being scanned is also called the input sampling rate. The native input sampling rate is determined by the optics and the pitch of the individual sensors. Some photosensor assemblies have multiple sets of line arrays, each set providing a different optical sampling rate. The present patent document is primarily concerned with photosensor arrays providing multiple optical sampling rates.

Typically, for CCD line arrays with charge transfer registers, charges from one exposure are transferred to a charge transfer register, and while the charges in the charge transfer register are being shifted and converted, the photosensors are exposed to light again. Typically, the exposure time for each scan line is substantially the same as the time required to shift and convert charges from the charge transfer register. Typically, scanning speed is limited primarily by analog-to-digital conversion time. For a photosensor assembly having multiple optical sampling rates (resulting in charge transfer registers with different numbers of stages), an exposure time optimized for one optical sampling rate will not be optimized for a different optical sampling rate. In particular, the time required to shift and convert charges from a charge transfer register for low optical sampling rate is less than the time required to shift and convert charges from a charge transfer register for a high optical sampling rate. For example, consider a photosensor assembly having two line arrays, one line array having 1,000 photosensors providing an optical sampling rate (in conjunction with an optics system) of 25 pixels per mm, and a second line array having 4,000 photosensors providing an optical sampling rate of 100 pixels per mm. For the first line array, the light intensity and charge transfer register shift rate may be adjusted so that in the time it takes to shift and convert 1,000 charges, a photosensor exposed to a white document will almost saturate. However, the second line array and charge transfer register must shift and convert four times as many charges, resulting in an exposure time that is four times longer. If the lamp intensity is optimized for the time required to shift and convert 1,000 charges, photosensors in both line arrays will saturate while being exposed during the time it takes to shift and convert 4,000 charges. If the lamp intensity is optimized for the time required to shift and convert 4,000 charges, scans using the first line array will be four times slower than optimal, because exposure times will be four times longer than the time required to shift and convert 1,000 charges.

In one commercially available scanner, the lamp intensity, and charge transfer register shift rates, are optimized for the lowest optical sampling rate to provide minimal scan times. When the higher optical sampling rates are used, each scanline requires multiple exposures, with each of the exposures having the same duration, with a fraction of the charges shifted and converted for each exposure, and with a fraction of the charges discarded for each exposure. For example, using the example of the second line array above, a single scanline requires four exposures. For the first exposure, the first 1,000 charges are shifted and converted, and the remaining 3,000 charges are rapidly shifted out and discarded. For the second exposure, the first 1,000 charges are rapidly shifted out and discarded, the second 1,000 charges are shifted and converted, and the last 2,000 charges are rapidly shifted out and discarded, and so forth.

Charge on the input line to the amplifier must be discharged after conversion, so amplifiers for line arrays commonly have a switch called a reset switch that discharges the input line after each conversion. The reset switch may be used to discard charges during rapid shifting.

### SUMMARY

A line array is exposed two times for each scanline. For the first exposure, charges are transferred from the line array to the charge transfer register after an appropriate exposure time that does not saturate photosensors. While the resulting charges are shifted and converted, the line array is exposed again for a relatively long duration, possibly resulting in overflow. The charges in the line array from the second exposure (during shifting and conversion) are discarded.

### BRIEF DESCRIPTION OF THE DRAWINGS

FIG. 1 is a block diagram of an example embodiment of a photosensor array.

FIG. 2 is an example embodiment of a timing diagram.

FIG. 3 is a flow chart of an example embodiment of a method.

### DETAILED DESCRIPTION

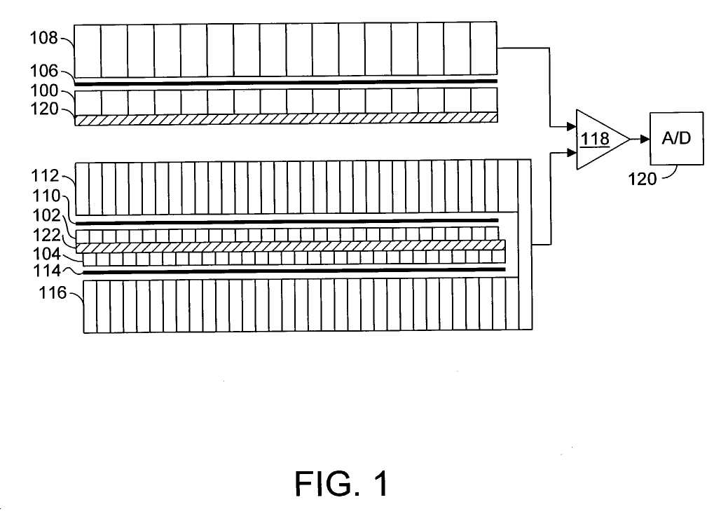

FIG. 1 illustrates an example embodiment of a photosensor assembly with line arrays having multiple pitches, resulting in multiple optical sampling rates. A first line array of photosensors 100 provides a first optical sampling rate. Two staggered line arrays of photosensors 102 and 104, when combined, provide an optical sampling rate that is higher than the optical sampling rate of the first line array. Charges from the first line array of photosensors are transferred through a charge transfer gate 106 to a first charge transfer register 108. Charges from line array 102 are transferred through a charge transfer gate 110 to a charge shift register 112, and charges from line array 104 are transferred through a charge transfer gate 114 to a charge transfer register 116. Charges from charge transfer registers 108, 112, and 116 are serially shifted to an amplifier 118, and then converted by an analog-to-digital converter 120. Individual stages in charge transfer register 108 are physically larger than individual stages in charge transfer registers 112 and 116, and therefore can hold more charge. Accordingly, the gain of the amplifier is preferably set to a lower gain when charge transfer register 108 is used relative to the gain used for charge transfer registers 112 and 116.

With intense light or long exposures, photosensor charge wells may saturate, and excess charge may spill over into adjacent photosensor charge wells, resulting in blooming (resulting bright areas in the digitized image are larger than the actual bright areas). In CCD arrays, it is common to provide overflow drains (also called antibloom drains) to bleed off any excess charges to prevent blooming. An overflow drain may be fabricated below the charge wells (called a vertical overflow drain), or adjacent to photodetectors (called a lateral overflow drain). In FIG. 1, a lateral overflow drain 120 bleeds off excess charges from line array 100, and a lateral overflow drain 122 bleeds off excess charges from line arrays 102 and 104.

When the photosensor assembly of FIG. 1 is used in an image scanner, and when photosensors in line array 100 are receiving light from the lamp that is scattered from a white area on a document, lamp intensity may be set so that the time interval required to shift and convert charges from charge transfer register 108 results in near saturation of photosensors in line array 100. This provides fast scans at the lower optical sampling rate. Photosensors in line arrays 102 and 104 are exposed to the same light intensity as the photosensors in line array 100. For line arrays 102 and 104, two exposures per scanline are used. During a first exposure, having a relatively short duration, desired charges are accumulated. As the desired charges are then converted, the photosensors are unavoidably exposed for a relatively long exposure time, during which time some photosensors may saturate or overflow. The resulting unwanted charges are discarded. The process then repeats with a relatively short exposure time, with the resulting charges being converted, followed by a relatively long exposure time, with the resulting charges being discarded.

There are multiple options for dumping unwanted charges. One option is to provide a variable threshold on the overflow drains, and completely drain all charges before the desired exposure. A variable threshold overflow drain that can completely discharge the photosensors is sometimes called an electronic shutter. In general, electronic shutters add cost and circuit area relative to an overflow drain with a fixed threshold. An alternative option is to have a fixed threshold on the overflow drains, and to transfer the charges to the charge transfer register, and to rapidly shift the charges without conversion during the short exposure time. The reset switch can be used to discharge charges to ground when conversion is not needed.

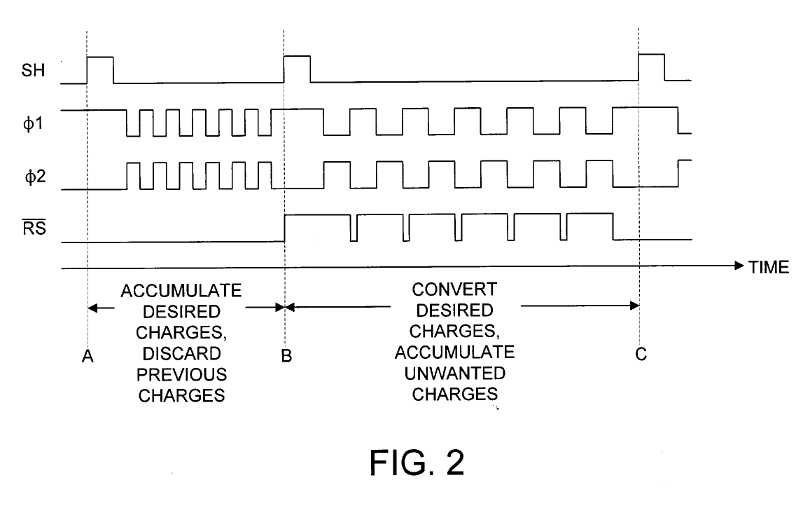

FIG. 2 is an example of a timing diagram illustrating the second option. Signal SH opens the charge transfer gates, allowing charge to transfer from the line arrays to the charge transfer registers. Signals φ1 and φ2 depict control signals for shifting charges in a two-phase charge transfer register. Signal RS is a control signal for a reset switch, at the input of the amplifier, that dumps charge when the signal is low in its inverted form as illustrated in FIG. 2. The number of shifts in FIG. 2 are for illustration only, and in a typical photosensor array there would be thousands of shifts.

In FIG. 2, the time from time “A” to time “B” corresponds to the first exposure in the above discussion of FIG. 1, and the time from time “B” to time “C” corresponds to the second exposure. At time “A”, accumulation of desired charges begins. During the time from time “A” to time “B”, unwanted charges accumulated during the previous exposure are discarded by rapidly shifting them to the reset switch without conversion. The time interval from time “A” to time “B” (and therefore the shift rate during the time interval from time “A” to time “B”) is designed to provide an appropriate exposure time for the higher optical sampling rate line arrays (FIG. 1, 102 and 104). At time “B”, the desired charges have accumulated and all the unwanted charges have been discarded. At time “B”, signal SH causes the desired charges accumulated during the time interval from time “A” to time “B” to be transferred to charge transfer registers. From time “B” to time “C”, the charges accumulated during time “A” to time “B” are shifted to the amplifier and converted by the analog-to-digital converter. The reset signal RS discharges the input line to the amplifier after each conversion. During the time from time “B” to time “C”, the line arrays are accumulating charge that may cause overflow to the overflow drains. At time “C”, conversion of the valid charges is complete, and signal SH causes the unwanted charges in the line arrays to be transferred to the charge transfer registers. The two exposures then repeat for a new scanline.

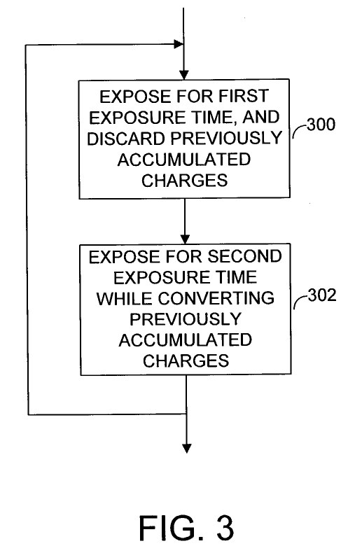

FIG. 3 illustrates an example embodiment of a method. At step 300, the photosensors are exposed to light for an appropriate exposure time, and earlier accumulated charges are discarded (for example, electronic switch, or by shifting without conversion). At step 302, the photosensors are exposed to light a second time while charges from the first exposure are converted.

The photosensor assembly of FIG. 1 is for purposes of example only. There may be a single line array for high optical sampling rate instead of two staggered arrays as illustrated. There may be more than two optical sampling rates. The ratio of optical sampling rates may be different than the illustrated ratio. There may be multiple line arrays dedicated to receiving different bands of wavelengths of light. Structures such as overflow drains and charge transfer registers may be shared by multiple line arrays. Charge transfer registers are typically split into multiple phases so that during shifting, each charge is shifted into an empty stage in a controlled direction. Two, three, and four phase charge transfer registers are known. The example of FIG. 1 is simplified for purposes of illustration, depicting only one charge transfer register stage for each photosensor.

The foregoing description of the present invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A method, comprising:
scanning, with first and second exposures for each scanline, where exposure times for the first and second exposures are substantially different;
converting, to digital values, charges resulting from each first exposure; and
discarding charges resulting from each second exposure.

2. The method of claim 1, where discarding is accomplished by discharging through an electronic shutter.

3. The method of claim 1, where discarding is accomplished by shifting charges to a reset switch.

4. A method, comprising:
(a) exposing an array of photosensors, to a scanline, for a first duration;
(b) converting charges resulting from step (a) to digital values;
(c) exposing the array of photosensors, during step (b), to the scanline, for a second duration, where the second duration is longer than the first duration;
(d) discarding the charges resulting from step (c); and
(e) repeating steps (a) through (d) for multiple scanlines.

5. The method of claim 4, where step (d) further comprises discarding through an electronic shutter.

6. The method of claim 4, where step (d) further comprises shifting charges, during step (a), to a switch that discharges.

7. An apparatus, comprising:
a photosensor assembly having a first line array and a second line array, where when scanning with the first line array there is one exposure for each scanline, and when scanning with the second line array there are two exposures for each scanline, and when scanning with the second line array the two exposures have different durations.

8. The apparatus of claim 7, where the apparatus is an image scanner.

9. An apparatus, comprising:
means for scanning a scanline, for a first exposure, with a line array of photosensors, resulting in first charges;
means for converting the first charges to digital values; and
means for discarding charges accumulated during conversion of the first charges.
